(19) United States
(12) Patent Application Publication
(10) Pub. No.: US 2008/0209811 A1
(43) Pub. Date: Sep. 4, 2008

(54) Door Drive Mechanism, Especially Revolving Door Drive Mechanism

(75) Inventor: Volker Bienek, Dortmund (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH +Co. KG, Ennepetal (DE)

(21) Appl. No.: 11/793,207

(22) PCT Filed: Nov. 14, 2005
(86) PCT No.: PCT/EP2005/012165

§ 371 Date: Jun. 18, 2007

(30) Foreign Application Priority Data
Dec. 17, 2004 (DE) 10 2004 061 628.0

(51) Int. Cl. E05F 15/02

(52) U.S. Cl. 49/139

(57) ABSTRACT

A door operator includes a housing; a hydraulic compartment; a pressure compartment; a drive unit disposed in the housing and coupleable to a door via an output shaft, the drive unit being associated with the hydraulic compartment; a hydraulic pump in hydraulic connection with the hydraulic compartment and the pressure compartment; a motor in driving relationship with the hydraulic pump; and a spring force accumulator disposed in the housing. The spring force accumulator is associated with the pressure compartment and coupled to the drive unit.

The invention relates to a door operator, in particular a swing door operator according to the generic part of patent claim 1.

Such a door operator is known from DE 295 21 068 U1. An overhead door closer with slide rail linkage is known from DE 40 38 720 C2, which has a cam drive unit allowing for an optimum door moment curve and a comfortable operation. In principle, this overhead door closer would therefore be suitable as a door operator as well; however, experiments, conducted during the course of the invention, have shown that applying oil pressure to the drive unit results in a very unfavourable transformation of the hydraulic pressure into the resulting movements of stroke/rotation and repeated stroke. Since about 75% of the output capacity to be developed is required for loading the spring force accumulator of such a door closer, whereas only about 25% of the output capacity needs to be delivered by the system for accelerating the door. As it is furthermore desirable to keep the narrow structural shape of such a door closer for door operators as well, the dimensions of the structural components cannot be adapted to the extreme high loads. Thus, although functionally and technically advantageous, the known overhead door closer is not suitable as a door operator.

Another swing door operator is known from DE 197 56 496 C2. This swing door operator has an electromechanical drive unit, which is provided with a drive motor and a gear and with a subsequent power transmission unit for the connected door. The power transmission unit has a spindle with a spindle nut partially overlapping the former, which spindle is non-positively and positively connected to a toothed rack. Although this swing door operator can be installed concealed, the door moment curve is not as optimal as with the above described door closers having the cam technology. However, on account of the larger construction width, installation in standard profiles is not possible.

Therefore it is the object of the present invention to provide a door operator of the species indicated in the generic part of patent claim 1, which can be installed completely concealed within the door profile or frame profile, and does not require any special construction of the door installation.

This problem is solved by the features of patent claim 1.

On account of its compact structure, the inventive door operator allows for a concealed installation within the door profile or frame profile and thus allows for a total integration with the door system.

Particularly the installation in common narrow door profiles is possible.

As an advantage, neither special door profiles nor any special constructions, which would interfere with the design of the door system, are necessary. Another advantage results from an economical mounting combined with a wide applicability and, moreover, it is possible to retrofit existing door systems with the inventive door operator. Another advantage results from the fact that, with the inventive door operator, a direct introduction of power via the piston for loading a spring force accumulator is possible, allowing to operate the closing of the door without any other additional auxiliary energy. Such a door operator is thus unconditionally suitable for fire-rated doors. Therefore, the possibility is given of avoiding unnecessarily loading the mechanical structural components. As the hydraulic pump of the inventive door operator is in direct hydraulic connection to the piston and to the spring force accumulator, a direct pressure application and thus a direct introduction of force into the spring force accumulator is the result, whereby the pre-loading of the spring force accumulator is accomplished. By this measure, the disadvantages explained at the beginning are completely eliminated.

The inventive door operator further achieves avoiding unnecessary stress on structural components, load on bearings, and any loss on account of friction or loss of efficiency.

It can thus be achieved that the torque required at the output shaft for opening the doors can be generated by means of a cam arrangement, for example, and that the spring loading work is simultaneously performed; however, at a higher degree of efficiency because the forces act directly on the piston and the drive unit is bypassed.

Through provisioning the pressure compartment, associated to the spring force accumulator, and a preferably provided specific hydraulic control, such as through the use of a solenoid valve, further hydraulic functions such as hydraulic hold-open or hydraulic closing sequence control are made possible.

Advantageous further developments of the invention are set forth in the dependent claims.

Further details, features and advantages of the invention will become apparent from the following description of exemplary embodiments, reference being made to the Figures, in which:

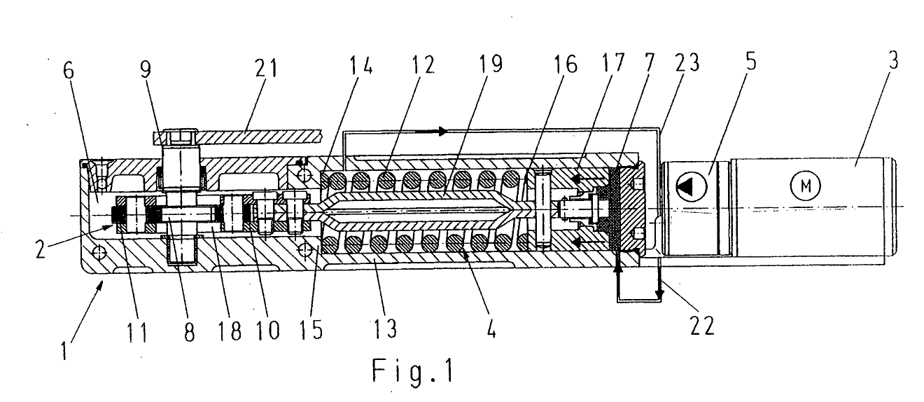

FIG. 1 shows a diagrammatically slightly simplified basic illustration of an embodiment of an inventive door operator,

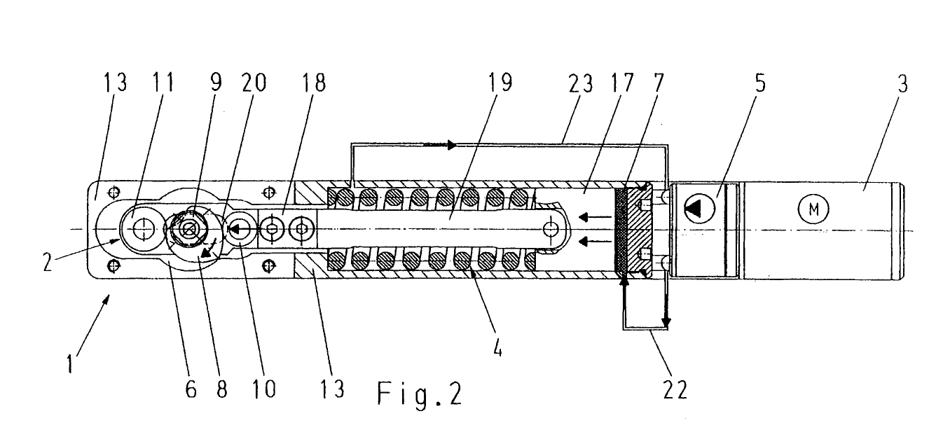

FIG. 2 shows a top view on the door operator according to FIG. 1.

FIG. 1 shows an inventive door operator 1, which in particular can be executed as a swing door operator. The door operator 1 has a drive unit 2, which, via an output shaft 9, can be coupled to a door not illustrated in FIG. 1, for example via a lever 21 and a slide channel with a sliding member. The drive unit 2 is disposed in a housing 13.

Furthermore, the door operator 1 has a motor 3, as well as a spring force accumulator 4, which is disposed in a housing 13 and coupled to the motor 3 and the drive unit 2.

As revealed in FIGS. 1 and 2, the motor 3 is in driving connection with a hydraulic pump 5. In the illustrated embodiment, the motor 3 and the pump 5 are disposed separately at the housing 13; however, they might be flange-mounted to or integral with the housing 13. The motor 3, via the hydraulic pump 5 and a first hydraulic line 22, is in hydraulic connection with a pressure compartment 7, which is associated to the spring force accumulator 4. Via a second hydraulic line 23, the motor 3 and the pump 5 are in hydraulic connection with a hydraulic compartment 6, which is associated to the drive unit 2.

In the embodiment illustrated in FIGS. 1 and 2, the drive unit 2 is formed as a cam drive. This cam drive has a cam disc 8 disposed on the output shaft 9, which passes through an oblong hole 20. The cam disc 8 cooperates with two force transmission rollers 10 and 11, which are disposed on both sides of the output shaft 9 on a cam plate assembly 18 and bear on different cam paths of the cam disc 8. Through rotating the output shaft 9, the compression spring 12 is loaded, because the piston rod 19, which is connected to the cam plate assembly 18, passes through an internal compartment of the compression spring 12 and is fastened to a spring loading piston 17. As, in this embodiment, the force transmission rollers are aligned towards the centre of the axis of the door operator 1 and secured to the cam plate assembly 18, the distance between them remains constant.

As revealed in FIG. 1, a spring loading piston 17 is disposed in the pressure compartment 7, which piston induces the force for loading a compression spring 12 directly into the latter. The spring loading piston 17 is connected to the cam plate assembly 18 via a piston rod 19, an introduction of force into the piston rod 19 being likewise carried out during application of forces within the pressure compartment 7.

Furthermore, FIG. 1 shows that one end 14 of the spring 12 bears against a housing wall 15 of the housing 13, whereas the other end 16 bears against the spring loading piston 17.

As revealed in FIGS. 1 and 2, the result is the extremely compact design explained at the beginning, which allows for a completely concealed installation in door profiles or frame profiles.

### LIST OF REFERENCES

1 door operator
2 drive unit
3 motor
4 spring force accumulator
5 hydraulic pump
6 hydraulic compartment
7 pressure compartment
8 cam disc
9 output shaft
10, 11 power transmission rollers
12 compression spring
13 housing
14 end
15 housing wall
16 end
17 spring loading piston or damping piston
18 cam plate assembly
19 piston rod
20 oblong hole
21 lever
22 first hydraulic line
23 second hydraulic line

1.-8. (canceled)

9. A door operator comprising:
a housing defining a hydraulic compartment;
a drive unit disposed in the housing and comprising an output shaft coupleable to a door;
a hydraulic pump in hydraulic connection with the hydraulic compartment and a pressure compartment;
a motor in driving connection with the hydraulic pump and in driving connection with the drive unit; and
a spring force accumulator disposed in the housing, the spring force accumulator being associated with the pressure compartment and coupled to the drive unit.

10. The door operator of claim 9, wherein the drive unit comprises a cam drive comprising a cam disc mounted on the output shaft and first and second force transmission rollers disposed on two sides of the output shaft and bearing on cam paths of the cam disc.

11. The door operator of claim 10, wherein the spring force accumulator comprises a spring loading piston and a compression spring, the compression spring having a first end bearing against a wall of the housing and a second end bearing against the spring loading piston.

12. The door operator of claim 11, wherein the pressure compartment is disposed adjacent to the spring loading piston.

13. The door operator of claim 11, further comprising a cam plate assembly connected to the spring loading piston, the first and second force transmission rollers being mounted on the cam plate assembly.

14. The door operator of claim 13, wherein the cam plate assembly has an oblong hole through which the output shaft extends.

15. The door operator of claim 9, further comprising a hydraulic control system which cooperates with the hydraulic pump and the motor.

16. The door operator of claim 9, wherein the motor comprises one of an alternating current micro-motor and a direct current micro-motor.

17. The door operator of claim 9, wherein the door operator is a swing door operator.

18. The door operator of claim 11, wherein the compression spring is arranged between the spring loading piston and the drive unit within the hydraulic compartment.

19. The door operator of claim 18, wherein the pressure compartment and the hydraulic compartment are arranged on opposing sides of the spring loading piston.
